(19) United States
(12) Patent Application Publication
(10) Pub. No.: US 2026/0067724 A1
(43) Pub. Date: Mar. 5, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Li NIU, Shenzhen (CN); Ting LU, Shenzhen (CN); Bo DAI, Shenzhen (CN); Yuan GAO, Shenzhen (CN)

(73) Assignee: ZTE CORPORATION, Shenzhen (CN)

(21) Appl. No.: 19/385,139

(22) Filed: Nov. 10, 2025

Related U.S. Application Data
(63) Continuation of application No. PCT/CN2023/093883, filed on May 12, 2023.

(51) Int. Cl. H04W 24/08; H04W 52/02

(52) U.S. Cl. CPC H04W 24/08; H04W 52/0235

(57) ABSTRACT

A wireless communication method is disclosed. The method comprises performing, by a wireless communication terminal, a measurement in a serving cell based on a low power signal, received from a wireless communication node in response to a starting condition of the measurement in the serving cell being satisfied.

### CROSS-REFERENCE TO RELATED PATENT APPLICATIONS

This application is a Continuation of US Application PCT/CN2023/093883, filed May 12, 2023, incorporated herein by reference in its entirety.

### TECHNICAL FIELD

This document is directed generally to wireless communications, and in particular to 5^{th} generation (5G) communications or 6^{th} generation (6G) communications.

### BACKGROUND

5G systems are designed and developed targeting both mobile telephony and vertical use cases. In addition to latency, reliability, and availability, user equipment (UE) energy efficiency is also critical to 5G. Currently, 5G devices may need to be recharged per week or day, depending on the individual's usage time. In general, 5G devices consume tens of milliwatts in Radio Resource Control (RRC) idle/inactive state and hundreds of milliwatts in the RRC connected state. Designs to prolong battery life are necessary for improving energy efficiency as well as providing a better user experience.

### SUMMARY

Energy efficiency is even more critical for the UEs without a continuous energy source, such as UEs using small rechargeable and single coin cell batteries. Among the vertical use cases, sensors and actuators are deployed extensively for monitoring, measuring, charging, etc. Generally, their batteries are not rechargeable and are expected to last at least a few years. Wearables include smartwatches, rings, eHealth-related devices, and medical monitoring devices. With typical battery capacity, it is challenging to sustain up to one or two weeks as required.

The power consumption depends on the configured length of wake-up periods, such as the Paging cycle. To meet the battery life requirements mentioned above, extended Discontinuous Reception (eDRX) cycles with large values are expected to be used, resulting in high latency, which is not suitable for services with requirements of both long battery life and low latency. For example, in the fire detection and extinguishment use case, the fire shutters may be closed, and the fire sprinklers may be turned on by the actuators within one to two seconds from the time the fire is detected by sensors; a long eDRX cycle cannot meet the delay requirements. Therefore, eDRX is apparently not suitable for latency-critical use cases.

Currently, the UEs need to periodically wake up once per Discontinuous Reception (DRX) cycle, which dominates the power consumption in periods with no signaling or data traffic. If the UEs can wake up only when they are triggered, such as by paging, power consumption could be dramatically reduced. This can be achieved by using a wake-up signal to trigger the main radio and a separate receiver with the ability to monitor the wake-up signal with ultra-low power consumption. The main radio works for data transmission and reception, which can be turned off or set to deep sleep unless it is turned on.

This document relates to methods, systems, and computer program products for a wireless communication.

One aspect of the present disclosure relates to a wireless communication method. In an embodiment, the wireless communication method includes: performing, by a wireless communication terminal, a measurement in a serving cell based on a low power signal, received from a wireless communication node in response to a starting condition of the measurement in the serving cell being satisfied.

Another aspect of the present disclosure relates to a wireless communication method. In an embodiment, the wireless communication method includes: transmitting, by a wireless communication node to a wireless communication terminal, a low power signal, to allow the wireless communication terminal to perform a measurement in a serving cell based on the low power signal in response to a starting condition of the measurement in the serving cell being satisfied.

Another aspect of the present disclosure relates to a wireless communication terminal. In an embodiment, the wireless communication terminal includes a communication unit and a processor. The processor is configured to: perform a measurement in a serving cell based on a low power signal, received from a wireless communication node through the communication unit in response to a starting condition of the measurement in the serving cell being satisfied.

Another aspect of the present disclosure relates to a wireless communication node. In an embodiment, the wireless communication node includes a communication unit and a processor. The processor is configured to: transmit, via the communication unit to a wireless communication terminal, a low power signal, to allow the wireless communication terminal to perform a measurement in a serving cell based on the low power signal in response to a starting condition of the measurement in the serving cell being satisfied.

Various embodiments may preferably implement the following features:

Preferably or in some embodiments, the starting condition of the measurement is determined according to a configuration transmitted from the wireless communication node to the wireless communication terminal.

Preferably or in some embodiments, an enablement indication for allowing the wireless communication terminal to determine the starting condition of the measurement is transmitted from the wireless communication node to the wireless communication terminal.

Preferably or in some embodiments, the measurement in the serving cell based on the low power signal comprises at least one of:
a Radio Link Monitoring, RLM, measurement based on the low power signal;
a Beam Failure Detection, BFD, measurement based on the low power signal; or
a Radio Resource Management, RRM, measurement based on the low power signal.

Preferably or in some embodiments, at least one of an RLM configuration, a BFD configuration, or an RRM configuration is applied for the measurement in response to the starting condition of the measurement is satisfied.

Preferably or in some embodiments, the starting condition of the measurement comprises at least one of:
a condition determined by the wireless communication terminal based on an indication enablement from the wireless communication node;
a measurement result of a Synchronization Signal/Physical Broadcast Channel Block, SSB, or a channel status information reference signal, CSI-RS, being greater than a threshold;
a variation of a measurement result of an SSB or a CSI-RS being greater than a variation threshold within a duration;
a measurement result of an SSB or a CSI-RS being greater than a summation of a threshold and an offset; or
a variation of a measurement result of an SSB or a CSI-RS being less than a variation threshold subtracted by an offset.

Preferably or in some embodiments, the wireless communication terminal stops performing the measurement in response to a stopping condition of the measurement being satisfied, and the stopping condition comprises at least one of:
a measurement result of an SSB or a CSI-RS being not greater than a threshold;
a variation of a measurement result of an SSB or a CSI-RS being not greater than a variation threshold within a duration;
a measurement result of an SSB or a CSI-RS being not greater than a summation of a threshold and an offset;
a variation of a measurement result of an SSB or a CSI-RS being not less than a variation threshold subtracted by an offset; or a number of the measurement being performed reaching a threshold.

Preferably or in some embodiments, the wireless communication terminal starts monitoring the low power signal in response to a starting condition of monitoring the low power signal being satisfied, and the starting condition of monitoring the low power signal comprises at least one of:
a condition determined by the wireless communication terminal based on an indication enablement from the wireless communication node;
a measurement result of an SSB or a CSI-RS being greater than a threshold; or
a variation of a measurement result of an SSB or a CSI-RS being greater than a variation threshold within a duration.

Preferably or in some embodiments, the wireless communication terminal stops monitoring the low power signal in response to a stopping condition of monitoring the low power signal being satisfied, and the stopping condition of monitoring the low power signal comprises at least one of:
a measurement result of an SSB or a CSI-RS being not greater than a threshold;
a variation of a measurement result of an SSB or a CSI-RS being not greater than a variation threshold within a duration; or
a duration of monitoring the low power signal expiring.

Preferably or in some embodiments, assistance information for assisting the wireless communication node to enable or disable a transmission of the low power signal is transmitted from the wireless communication terminal to the wireless communication node, and the assistance information comprises at least one of:
the wireless communication terminal desiring the low power signal;
the wireless communication terminal desiring a deep sleep mode;
whether the starting condition of the measurement in the serving cell being satisfied;
whether a starting condition of monitoring the low power signal being satisfied;
a change of a state of whether the starting condition of the measurement in the serving cell being satisfied;
a change of a state of whether a starting condition of monitoring the low power signal being satisfied; or
the wireless communication terminal desiring a long Discontinuous Reception, DRX, cycle for supporting the low power signal.

Preferably or in some embodiments, an indication configuration for assistance information for assisting the wireless communication node to enable or disable a transmission of the low power signal is transmitted from the wireless communication node to the wireless communication terminal, and the indication configuration comprises at least one of:
an indication enabling the wireless communication terminal to report whether the wireless communication terminal desiring the low power signal;
an indication enabling the wireless communication terminal to report whether the wireless communication terminal desiring a deep sleep mode;
an indication enabling the wireless communication terminal to report whether the starting condition of the measurement in the serving cell being satisfied;
an indication enabling the wireless communication terminal to report whether a starting condition of monitoring the low power signal being satisfied;
an indication enabling the wireless communication terminal to report a change of a state of whether the starting condition of the measurement in the serving cell being satisfied;
an indication enabling the wireless communication terminal to report a change of a state of whether a starting condition of monitoring the low power signal being satisfied; or
an indication enabling the wireless communication terminal to report the wireless communication terminal desiring a long Discontinuous Reception, DRX, cycle for supporting the low power signal.

Preferably or in some embodiments, an occasion of the low power signal is determined by at least one of:
a first offset relative to an on-duration time for determining a first end of the occasion of the low power signal;
a second offset relative to an on-duration time for determining a second end of the occasion of the low power signal;
a duration of the occasion of the low power signal where the low power signal is able to be transmitted;
a third offset relative to an occasion of a piece of Downlink Control Information, DCI, for determining a first end of the occasion of the low power signal; or
a fourth offset relative to an occasion of a piece of DCI for determining a second end of the occasion of the low power signal.

Preferably or in some embodiments, a resource for transmitting the low power signal is determined by at least one of:
a low power signal resource pool comprising low power signal resources; or
an index indicating one of the low power signal resources as the resource for transmitting the low power signal, wherein the index is carried by an enabling message for enabling the low power signal.

Preferably or in some embodiments, the wireless communication terminal performs at least one of:
detecting the low power signal based on an identity of a resource for transmitting the low power signal;
detecting the low power signal based on an indicated position in DCI;
detecting the low power signal based on an identity carried by the low power signal; or
refraining from monitoring a physical downlink control channel, PDCCH, based on time information carried by the low power signal.

Preferably or in some embodiments, the wireless communication terminal performs at least one of:
receiving, from the wireless communication node, a long DRX cycle configuration for the low power signal; or
receiving, from the wireless communication node, an enabling message for enabling a long DRX cycle configuration for the low power signal.

Preferably or in some embodiments, the low power signal comprises at least one of: a Low Power Wake-Up Signal, LP-WUS, or a Low Power Synchronization Signal, LP-SS.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a signal according to an embodiment of the present disclosure.

FIG. 2 shows an example of a signal according to an embodiment of the present disclosure.

FIG. 3 shows an example of a signal according to an embodiment of the present disclosure.

FIG. 4 shows an example of a signal according to an embodiment of the present disclosure.

FIG. 5 shows examples of a signal according to an embodiment of the present disclosure.

FIG. 6 shows an example of a schematic diagram of a wireless communication terminal according to an embodiment of the present disclosure.

FIG. 7 shows an example of a schematic diagram of a wireless communication node according to an embodiment of the present disclosure.

FIGS. 8 and 9 show flowcharts of wireless communication methods according to some embodiments of the present disclosure.

### DETAILED DESCRIPTION

Some embodiments of the present disclosure discuss low power signals or receivers for power-sensitive, small form-factor devices, including Internet of Things (IoT) devices (such as industrial sensors and controllers) and wearable devices.

In some embodiments of the present disclosure, the low power signal may include at least one of a Low Power Wake-Up Signal (LP-WUS) or a Low Power Synchronization Signal (LP-SS). In some embodiments of the present disclosure, the low power signal could be the LP-WUS (Low Power Wake-Up Signal), the LP-SS (Low Power Synchronization Signal), or another signal.

In the paragraphs below, details will be described along with some examples, but the present disclosure is not limited to the example below.

### Aspect 1 (Relaxed Measurement Based on the LP-WUS)

In some embodiments, the UE may perform a serving cell measurement. In some embodiments, the serving cell measurement may include the RLM (Radio Link Monitoring), BFD (Beam Failure Detection) or RRM (Radio Resource Management) measurement. In some embodiments, the RLM (Radio Link Monitoring), BFD (Beam Failure Detection) or RRM (Radio Resource Management) measurement performed based on the SSB (Synchronization Signal/Physical Broadcast Channel Block) and/or CSI-RS (channel status information reference signal) in a serving cell requires the UE to wake up and turn on MR (Main Radio). To save the UE power consumption, the UE may perform the relaxed serving cell measurement (also referred to as relaxed measurement in the present disclosure) based on the low power signal in the serving cell. In some embodiments, the relaxed serving cell measurement based on the low power signal may include at least one of the relaxed RLM, the relaxed BFD, or the relaxed RRM measurement based on the LP-WUS or LP-SS or other signal. In some embodiments, the relaxed measurement in the serving cell includes that the UE measures or detects the low power signal instead of the SSB and/or CSI-RS in the serving cell, or the UE measures or detects the SSB and/or CSI-RS in the serving cell every longer periodicity when the low power signal is configured. In some embodiments, the UE performing the relaxed measurement based on the low power signal may indicate the UE may perform the relaxed RLM, BFD, or RRM measurement in response to the low power signal being received.

In some embodiments, the UE measures or monitors the SSB and/or CSI-RS in the serving cell. When the starting condition of performing the relaxed RLM, BFD, or RRM measurement based on the low power signal in the serving cell is satisfied, the UE may perform the relaxed measurement based on the low power signal in the serving cell, or the UE could report to the gNB (gNodeB) that the starting condition of performing the relaxed RLM, BFD, or RRM measurement based on the low power signal is satisfied. When the stopping condition (also referred to as end condition or ending condition in the present disclosure) of performing the relaxed RLM, BFD, or RRM measurement based on the low power signal is satisfied, the UE measures or monitors the SSB and/or CSI-RS in the serving cell, or the UE could report to the gNB that the stopping condition of performing the relaxed RLM, BFD, or RRM measurement based on the low power signal is satisfied.

In some embodiments, the condition(s) (e.g., the starting condition and/or ending condition) of performing the relaxed serving cell measurement in the serving cell may include one or more of the following:

(1) The gNB could enable the UE to determine the starting condition and/or ending condition of performing the relaxed RLM, BFD, or RRM measurement based on the low power signal via an RRC message or an SIB (System Information block). The gNB could configure the UE the parameters about the starting condition and/or ending condition of performing the relaxed RLM, BFD, or RRM measurement based on the low power signal. If the UE receives the parameters, the UE could determine whether the starting condition and/or ending condition of performing the relaxed RLM, BFD, or RRM measurement based on the low power signal is satisfied according to the parameters.

(2) If the UE is not at a cell edge, the UE may perform the relaxed RLM, BFD, or RRM measurement based on the low power signal in the serving cell. In such a case, the starting condition of performing the relaxed measurement is that the measurement result of the SSB and/or CSI-RS is higher than a threshold. When the measurement result of the SSB and/or CSI-RS is high than a threshold, the UE starts to perform relaxed RLM, BFD, or RRM measurement based on the low power signal in the serving cell, or the UE could report to the gNB that the starting condition of performing the relaxed RLM, BFD, or RRM measurement based on the low power signal is satisfied. The gNB may, transmit to the UE via an RRC message or broadcast via an SIB, a threshold for the relaxed serving cell measurement in the SIB.

If the UE is at a cell edge, the UE may not perform the relaxed RLM, BFD, or RRM measurement based on the low power signal in the serving cell. In such a case, the stopping conditions of relaxed measurement is that the measurement result of the SSB and/or CSI-RS is not higher than a threshold. When the measurement result of the SSB and/or CSI-RS is not high than a threshold, the UE stops to perform relaxed RLM, BFD, or RRM measurement based on the low power signal in the serving cell, or the UE could report to the gNB that the stopping condition of performing the relaxed RLM, BFD, or RRM measurement based on the low power signal is satisfied.

The gNB may, transmit to the UE via an RRC message or broadcast via an SIB, the threshold for the relaxed RLM, BFD, or RRM measurement.

(3) If the UE is static or has low mobility, the UE may perform the relaxed RLM, BFD, or RRM measurement based on the low power signal in the serving cell. In such a case, the starting condition of performing the relaxed measurement is that the variation of the measurement result of the SSB and/or CSI-RS is less than a threshold. When the variation of the measurement result of the SSB and/or CSI-RS is less than a threshold within a duration, the UE starts to perform the relaxed RLM, BFD, or RRM measurement based on the low power signal in the serving cell or the UE could report to the gNB that the starting condition of performing the relaxed RLM, BFD, or RRM measurement based on the low power signal is satisfied.

If the UE is not static or does not have low mobility, the UE may not perform the relaxed RLM, BFD, or RRM measurement based on the low power signal in the serving cell. In such a case, the stopping conditions of relaxed measurement is that the variation of the measurement result of the SSB and/or CSI-RS is not less than a threshold. When the variation of the measurement result of the SSB and/or CSI-RS is not less than a threshold within a duration, the UE stops to perform the relaxed RLM, BFD, or RRM measurement based on the low power signal in the serving cell or the UE could report to the gNB that the stopping condition of performing the relaxed RLM, BFD, or RRM measurement based on the low power signal is satisfied.

The gNB may, transmit to the UE via an RRC message or broadcast via an SIB, the threshold and/or the duration for the relaxed RLM, BFD, or RRM measurement.

(4) If the UE could satisfy the condition of performing the relaxed RLM, BFD, or RRM measurement based on the SSB and/or CSI-RS, the UE may perform the relaxed RLM, BFD, or RRM measurement based on the low power signal in the serving cell. In such a case, the starting condition of performing the relaxed RLM, BFD, or RRM measurement based on the low power signal is that the measurement result of the SSB and/or CSI-RS is higher than an offset adding to the threshold of the starting condition of performing the relaxed RLM, BFD, or RRM measurement based on the SSB and/or CSI-RS. When the measurement result of the SSB and/or CSI-RS is higher than a threshold (e.g., a value X), the UE could start the relaxed RLM, BFD, or RRM measurement based on the SSB and/or CSI-RS. When the measurement result of the SSB and/or CSI-RS is higher than the value that an offset adds to the threshold of the starting condition of performing the relaxed RLM, BFD, or RRM measurement based on the SSB and/or CSI-RS (e.g., an offset+the value X), the UE starts the relaxed RLM, BFD, or RRM measurement based on the low power signal in the serving cell or the UE could report to the gNB that the starting condition of performing the relaxed RLM, BFD, or RRM measurement based on the low power signal is satisfied.

The stopping conditions of the relaxed RLM, BFD, or RRM measurement based on the low power signal is that the measurement result of the SSB and/or CSI-RS is not higher than an offset adding to the threshold of the starting condition of performing the relaxed RLM, BFD, or RRM measurement based on the SSB and/or CSI-RS. When the measurement result of the SSB and/or CSI-RS is higher than a threshold (e.g., a value X), the UE could start the relaxed RLM, BFD, or RRM measurement based on the SSB and/or CSI-RS. When the measurement result of the SSB and/or CSI-RS is not higher than the value that an offset adds to the threshold of the starting condition of performing the relaxed RLM, BFD, or RRM measurement based on the SSB and/or CSI-RS (e.g., an offset+the value X), the UE starts the relaxed RLM, BFD, or RRM measurement based on the low power signal in the serving cell or the UE could report to the gNB that the stopping condition of performing the relaxed RLM, BFD, or RRM measurement based on the low power signal is satisfied.

The gNB may, transmit to the UE via an RRC message or broadcast via an SIB, the offset and/or the threshold for the relaxed RLM, BFD, or RRM measurement.

(5) If the UE could satisfy the condition of performing the relaxed RLM, BFD, or RRM measurement based on the SSB and/or CSI-RS, the UE may perform the relaxed RLM, BFD, or RRM measurement based on the low power signal in the serving cell. In such a case, the starting condition of performing the relaxed RLM, BFD, or RRM measurement based on the low power signal is that the variation of the measurement result of the SSB and/or CSI-RS within a duration is less than a threshold (e.g., the threshold of the starting condition of performing the relaxed RLM, BFD, or RRM measurement based on the SSB and/or CSI-RS) subtracted by an offset.

For example, when the variation of the measurement result of the SSB and/or CSI-RS within a duration is less than a threshold (e.g., a value X), the UE could start the relaxed RLM, BFD, or RRM measurement based on the SSB and/or CSI-RS. When the variation of the measurement result of the SSB and/or CSI-RS within a duration is less than the value that the threshold of the starting condition of performing the relaxed RLM, BFD, or RRM measurement based on the SSB and/or CSI-RS subtracted by an offset (e.g., the X−the offset), the UE starts the relaxed RLM, BFD, or RRM measurement based on the low power signal in the serving cell or the UE could report to the gNB that the starting condition of performing the relaxed RLM, BFD, or RRM measurement based on the low power signal is satisfied.

The stopping conditions of the relaxed RLM, BFD, or RRM measurement based on the low power signal is that the measurement result of the SSB and/or CSI-RS is not less than the threshold of the starting condition of performing the relaxed RLM, BFD, or RRM measurement based on the SSB and/or CSI-RS subtracted by an offset. When the variation of the measurement result of the SSB and/or CSI-RS within a duration is less than a threshold (e.g., a value X), the UE could start the relaxed RLM, BFD, or RRM measurement based on the SSB and/or CSI-RS. When the variation of the measurement result of the SSB and/or CSI-RS within a duration is not less than the value that an the threshold of the starting condition of performing the relaxed RLM, BFD, or RRM measurement based on the SSB and/or CSI-RS subtracted by an offset (e.g., the value X−the offset), the UE starts the relaxed RLM, BFD, or RRM measurement based on the low power signal in the serving cell or the UE could report to the gNB that the stopping condition of performing the relaxed RLM, BFD, or RRM measurement based on the low power signal is satisfied.

The gNB may, transmit to the UE via an RRC message or broadcast via an SIB, the offset, the threshold, and/or the duration for the relaxed RLM, BFD, or RRM measurement.

(6) If the relaxed RLM, BFD, or RRM measurement based on the low power signal only lasts a duration, the stopping condition of performing the relaxed RLM, BFD, or RRM measurement based on the low power signal is that the measurement number or time reach a threshold. When the number of the relaxed RLM, BFD, or RRM measurement based on the low power signal reach a threshold, the UE stops the relaxed RLM, BFD, or RRM measurement based on the low power signal or the UE could report to the gNB that the stopping condition of performing the relaxed RLM, BFD, or RRM measurement based on the low power signal is satisfied.

In some embodiments, when the UE starts the relaxed RLM, BFD, or RRM measurement based on the low power signal, the UE starts a timer. When the timer is running, the UE performs the relaxed RLM, BFD, or RRM measurement based on the low power signal. When the timer expires, the UE stops the relaxed RLM, BFD, or RRM measurement based on the low power signal or the UE could report to the gNB that the stopping condition of performing the relaxed RLM, BFD, or RRM measurement based on the low power signal is satisfied.

The gNB may, transmit to the UE via an RRC message or broadcast via an SIB, the measurement number or the time duration for the relaxed RLM, BFD, or RRM measurement.

(7) If the relaxed RLM, BFD, or RRM measurement based on the low power signal is performed, the corresponding RLM configuration, BFD configuration, and/or RRM configuration for the relaxed RLM, BFD, or RRM measurement is applied. The gNB may configure an RLM configuration, BFD configuration, and/or RRM configuration for the relaxed RLM, BFD, or RRM measurement based on the low power signal via an RRC message. The RLM configuration could include one or more of the following: a longer parameter t310, a longer parameter n310, a less parameter n311, a threshold of the OOS (out of sync), a threshold of the IN (in sync), etc. The BFD configuration could include one or more of the following: a less beam FailureInstanceMaxCount, longer beamFailureDetectionTimer, a threshold of the OOS, a threshold of the IN, etc. The RRM configuration could include one or more of the following: a longer periodicity of a measurement gap, a duration of a measurement gap, a start time of a measurement gap.

### Aspect 2 (Condition of Low Power Signal)

In some embodiments, in the connected mode (e.g., RRC connected mode), the UE could monitor the low power signal for power saving. For example, If the UE detects the low power signal, the UE could wake up. When the starting condition of monitoring the low power signal in the serving cell is satisfied, the UE could monitor the low power signal in the serving cell, or the UE could report to the gNB that the starting condition of monitoring the low power signal is satisfied. When the stopping condition of monitoring the low power signal is satisfied, the UE stops monitoring the low power signal in the serving cell, or the UE could report to the gNB that the stopping condition of monitoring the low power signal is satisfied.

In some embodiments, the starting condition and/or ending condition of monitoring the low power signal in the serving cell may include one or more of the following:

(1) The gNB could enable the UE to determine the starting condition and/or ending condition of monitoring the low power signal via an RRC message or an SIB. The gNB could configure the UE the parameters about the starting condition and/or ending condition of monitoring the low power signal. If the UE receives the parameters, the UE could determine whether the condition of monitoring the low power signal is satisfied.

(2) If the UE is not at a cell edge, the UE could perform monitoring the low power signal in the serving cell, and the starting condition of monitoring the low power signal is that the measurement result of the SSB and/or CSI-RS is higher than a threshold. When the measurement result of the SSB and/or CSI-RS is higher than a threshold, the UE starts to monitor the low power signal, or the UE could report to the gNB that the starting condition of monitoring the low power signal is satisfied. The gNB could, transmit to the UE via an RRC message or broadcast via an SIB, the threshold for monitoring the low power signal in an SIB.

If the UE is at a cell edge, the UE may not perform monitoring the low power signal in the serving cell, and the stopping conditions of monitoring the low power signal is that the measurement result of the SSB and/or CSI-RS is not higher than a threshold. When the measurement result of the SSB and/or CSI-RS is not higher than a threshold, the UE stops to perform monitoring the low power signal, or the UE could report to the gNB that the stopping condition of monitoring the low power signal is satisfied.

The gNB could, transmit to the UE via an RRC message or broadcast via an SIB, the threshold for monitoring the low power signal.

(3) If the UE is static or has a low mobility, the UE could perform monitoring the low power signal in the serving cell, and the starting condition of performing the relaxed measurement is that the variation of the measurement result of the SSB and/or CSI-RS is less than a threshold within a duration. When the variation of the measurement result of the SSB and/or CSI-RS is less than a threshold within a duration, the UE starts to perform monitoring the low power signal in the serving cell or the UE could report to the gNB that the starting condition of monitoring the low power signal is satisfied.

If the UE is not static or does not have a low mobility, the UE may not perform monitoring the low power signal in the serving cell, and the stopping conditions of relaxed measurement is that the variation of the measurement result of the SSB and/or CSI-RS is not less than a threshold. When the variation of the measurement result of the SSB and/or CSI-RS is not less than a threshold within a duration, the UE stops to perform monitoring the low power signal in the serving cell or the UE could report to the gNB that the stopping condition of monitoring the low power signal is satisfied.

The gNB could, transmit to the UE via an RRC message or broadcast via an SIB, the threshold and/or the duration for monitoring the low power signal.

(4) If the monitoring the low power signal only lasts a time duration, the stopping condition of monitoring the low power signal is that the time of monitoring the low power signal reaches a threshold. When the time of monitoring the low power signal reaches a threshold, the UE stops monitoring the low power signal.

In some embodiments, when the UE starts monitoring the low power signal, the UE may start a timer. When the timer is running, the UE performs monitoring the low power signal. When the timer expires, the UE stops monitoring the low power signal.

The gNB could, transmit to the UE via an RRC message or broadcast via an SIB, the time duration and/or timer value for monitoring the low power signal.

### Aspect 3 (UE Assistance Information)

In some embodiments, the UE could provide some information to assist the gNB to enable or disable the low power signal for the UE (e.g., to start or stop transmitting the low power signal to the UE). For example, if the condition of supporting the low power signal is satisfied and the UE inform the gNB about it, the gNB may enable the low power signal for the UE.

In some embodiments, the gNB may configure the UE to report the UE information to the gNB via an RRC message. The RRC message could be an RRC reconfiguration message, a UE Information Request, or another message. The gNB may transmit one or more configurations related to one or more conditions to the UE. If the one or more conditions is satisfied, the UE could report the UE information to the gNB.

In some embodiments, the one or more configurations could include one or more of the following:

(1) Enabling the UE to report whether the UE desires the low power signal. The gNB may request the UE to report whether the UE desires the low power signal in an RRC connected mode or an RRC idle/inactive mode. If the UE desires a low power signal configuration and inform the gNB, the gNB may configure or enable the low power signal.

(2) Enabling the UE to report whether the UE desires a deep sleep mode. The gNB may request the UE to report whether the UE desires a deep sleep mode in an RRC connected mode or an RRC idle/inactive mode. If the UE desires a deep sleep mode configuration and inform the gNB, the gNB could wake the UE up via the low power signal.

(3) Enabling the UE to report whether the condition of performing the relaxed RLM, BFD, or RRM measurement based on the low power signal is satisfied (e.g., after the starting condition of performing the relaxed RLM, BFD, or RRM measurement based on the low power signal being met and before the end condition of performing the relaxed RLM, BFD, or RRM measurement based on the low power signal being met) in an RRC connected mode. The gNB may request the UE to report whether the condition of performing the relaxed RLM, BFD, or RRM measurement based on the low power signal is satisfied in an RRC connected mode. If the condition of performing the relaxed RLM, BFD, or RRM measurement based on the low power signal is satisfied and the UE inform it to the gNB, the gNB could enable the low power signal.

(4) Enabling the UE to report whether the condition of monitoring the low power signal is satisfied (e.g., after the starting condition of monitoring the low power signal being met and before the end condition of monitoring the low power signal being met) in the RRC connected mode. The gNB may request the UE to report whether the condition of monitoring the low power signal is satisfied in the RRC connected mode. If the condition of monitoring the low power signal is satisfied and informed to the gNB by the UE, the gNB could enable the low power signal.

(5) Enabling the UE to report whether the condition of performing the relaxed RLM, BFD, or RRM measurement based on the low power signal is not satisfied in an RRC connected mode. The gNB may request the UE to report whether the condition of performing the relaxed RLM, BFD, or RRM measurement based on the low power signal is satisfied in an RRC connected mode. If the condition of performing the relaxed RLM, BFD, or RRM measurement based on the low power signal is not satisfied and the UE inform this to the gNB, the gNB could disable the low power signal.

(6) Enabling the UE report whether the UE does not satisfy the condition of monitoring the low power signal in the RRC connected mode. The gNB may request the UE to report whether the UE cannot satisfy the condition of monitoring the low power signal in the RRC connected mode. If the UE cannot satisfy the condition of monitoring the low power signal and inform the gNB about it, the gNB could disable the low power signal.

(7) Enabling the UE to report the change of state that the condition of performing the relaxed RLM, BFD, or RRM measurement based on the low power signal is satisfied in an RRC connected mode. The gNB may request the UE to report whether the condition of performing the relaxed RLM, BFD, or RRM measurement based on the low power signal is satisfied after such a condition is not satisfied or whether the UE does not satisfy the condition of performing the relaxed RLM, BFD, or RRM measurement based on the low power signal after such a condition is satisfied in an RRC connected mode. If the UE could satisfy the condition of performing the relaxed RLM, BFD, or RRM measurement based on the low power signal in a first period and could not satisfy the condition of performing the relaxed RLM, BFD, or RRM measurement based on the low power signal in a second period immediately after the first period, and inform the gNB about it, the gNB could disable the low power signal. If the UE could not satisfy the condition of performing the relaxed RLM, BFD, or RRM measurement based on the low power signal in a first period and could satisfy the condition of performing the relaxed RLM, BFD, or RRM measurement based on the low power signal in a second period immediately after the first period, and inform the gNB about it, the gNB could enable the low power signal.

(8) Enabling the UE to report the change of the state that the UE satisfies the condition of monitoring the low power signal in the RRC connected mode. The gNB may request the UE to report whether the UE satisfies the condition of monitoring the low power signal after the UE does not satisfy the condition or whether the UE does not satisfy the condition of monitoring the low power signal after the UE satisfies the condition in the RRC connected mode. If the UE could satisfy the condition of monitoring the low power signal and then cannot satisfy the condition of monitoring the low power signal, and inform the gNB about it, the gNB could disable the low power signal. If the UE cannot satisfy the condition of monitoring the low power signal and then could satisfy the condition of monitoring the low power signal, and inform the gNB about it, the gNB could enable the low power signal.

(9) Enabling the UE to report whether the UE desires a long DRX cycle for supporting low power signal. The gNB may request the UE to report whether the UE desires a long DRX cycle for supporting the low power signal in an RRC connected mode or an RRC idle/inactive mode. If the UE desires a long DRX cycle configuration and inform the gNB, the gNB may configure or enable the long DRX cycle configuration.

In some embodiments, the UE could report the UE information to the gNB via an RRC message or an MAC CE. In some embodiments, the RRC message could be the UE assistance information message, the UE Information response or another message.

In some embodiments, the MAC CE could carry the indication about the UE information.

In some embodiments, the UE information could include one or more of the following:

(1) If the gNB enables the UE to report whether the UE desires the low power signal, and the UE desires a low power signal configuration to save the UE power, the UE could inform the gNB that the UE in an RRC connected mode or an RRC idle/inactive mode.

(2) If the gNB enables the UE to report whether the UE desires a deep sleep mode, and the UE desires a deep sleep mode configuration, the UE could inform the gNB that the UE desires a deep sleep mode in an RRC connected mode or an RRC idle/inactive mode.

(3) If the gNB enables the UE to report whether the condition of performing the relaxed RLM, BFD, or RRM measurement based on the low power signal is satisfied, and the condition of performing the relaxed RLM, BFD, or RRM measurement based on the low power signal is satisfied (e.g., after the starting condition of performing the relaxed RLM, BFD, or RRM measurement based on the low power signal being met and before the end condition of performing the relaxed RLM, BFD, or RRM measurement based on the low power signal being met), the UE could inform the gNB that the condition of performing the relaxed RLM, BFD, or RRM measurement is satisfied based on the low power signal in an RRC connected mode.

(4) If the gNB enables the UE to report whether the condition of monitoring the low power signal is satisfied, and the condition of monitoring the low power signal is satisfied (e.g., after the starting condition of monitoring the low power signal being met and before the end condition of monitoring the low power signal being met), the UE could inform the gNB that the condition of monitoring the low power signal is satisfied in the RRC connected mode.

(5) If the gNB enables the UE to report whether the UE does not satisfy the condition of performing the relaxed RLM, BFD, or RRM measurement based on the low power signal, and the UE does not satisfy the condition of performing the relaxed RLM or BFD or RRM, the UE could inform the gNB that the UE does not satisfy the condition of performing the relaxed RLM, BFD, or RRM measurement based on the low power signal in an RRC connected mode.

(6) If the gNB enables the UE to report whether the UE does not satisfy the condition of monitoring the low power signal, and the UE cannot satisfy the condition of monitoring the low power signal, the UE could inform the gNB that the UE does not satisfy the condition of monitoring the low power signal in the RRC connected mode.

(7) If the gNB enables the UE to report the change of state that the condition of performing the relaxed RLM, BFD, or RRM measurement based on the low power signal is satisfied, and the state that the condition of performing the relaxed RLM, BFD, or RRM measurement based on the low power signal is satisfied changes, for example, the UE could not satisfy the condition of performing the relaxed RLM, BFD, or RRM measurement based on the low power signal and then could satisfy the condition of performing the relaxed RLM, BFD, or RRM measurement based on the low power signal, or the UE could satisfy the condition of performing the relaxed RLM, BFD, or RRM measurement based on the low power signal and then could not satisfy the condition of performing the relaxed RLM, BFD, or RRM measurement based on the low power signal, the UE could inform the gNB that the state changes in an RRC connected mode.

(8) If the gNB enables the UE to report the change of the state that the UE satisfies the condition of monitoring the low power signal, and the state that the UE satisfies the condition of monitoring the low power signal changes, for example, the UE cannot satisfy the condition of monitoring the low power signal and then could satisfy the condition of monitoring the low power signal, or the UE could satisfy the condition of monitoring the low power signal and then cannot satisfy the condition of monitoring the low power signal, the UE could inform the gNB that the state changes in the RRC connected mode.

(9) If the gNB enables the UE to report whether the UE desires a long DRX cycle for supporting low power signal, the UE could inform the gNB that the UE desires a long DRX cycle for supporting low power signal in an RRC connected mode or an RRC idle/inactive mode.

### Aspect 4 (Occasion)

In some embodiments, the UE could enter a deep sleep mode for power saving. In this mode, the UE may only monitor the low power signal. If the UE detects the low power signal, the UE could wake up and start to monitor the PDCCH (physical downlink control channel). If the UE does not detect any low power signal, the UE could continue the deep sleep mode.

In some embodiments, the UE could enter a deep sleep mode during the non-inactive time. During the non-inactive time, there are some occasions for the low power signal. The gNB may configure the occasion(s) of the low power signal(s) via the one or more of the following:

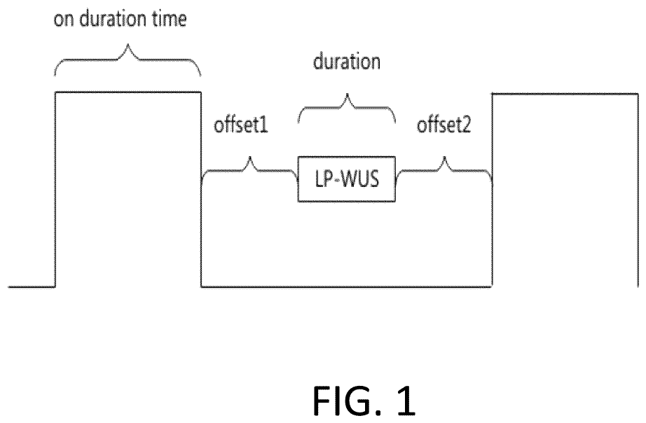

(1) The start time of an occasion of the low power signal can be determined by configuring an offset1 after the on-duration time. The gNB may configure the offset1 (e.g., via an RRC message). The UE could determine the start time of the occasion of the low power signal based the offset1 after the on-duration time (see FIG. 1).

(2) The end time of an occasion of the low power signal can be determined by configuring offset2 before the on-duration time. The gNB may configure the offset2 (e.g., via an RRC message). The UE could determine the end time of the occasion of the low power signal based the offset2 before the on-duration time (see FIG. 1).

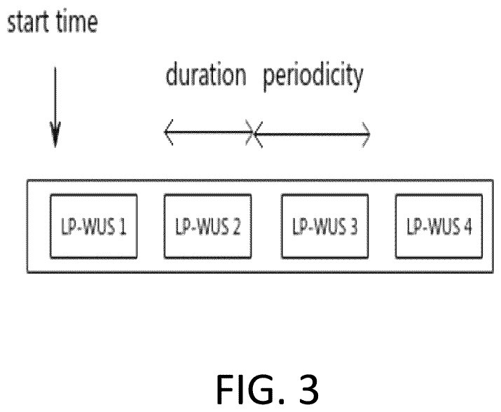

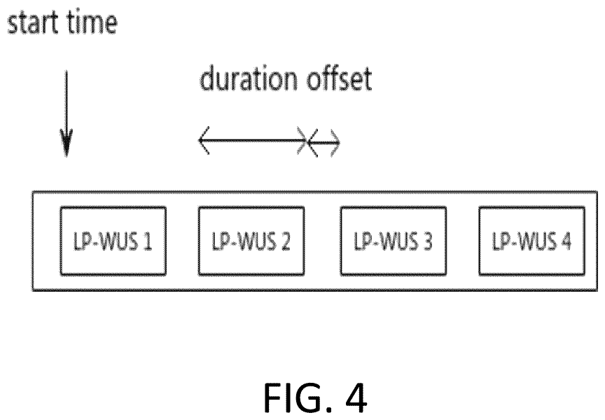

(3) The duration of one or more occasions of the low power signal is a duration where the low power signal could be transmitted. The gNB may configure the duration (e.g., via an RRC message). In some embodiments, the duration may include multiple occasions of the low power signal (see FIG. 3 and FIG. 4). The UE could determine the duration of the one or more occasions of the low power signal based on parameters of this duration. The UE could monitor the low power signal continuously during this duration (see FIG. 1).

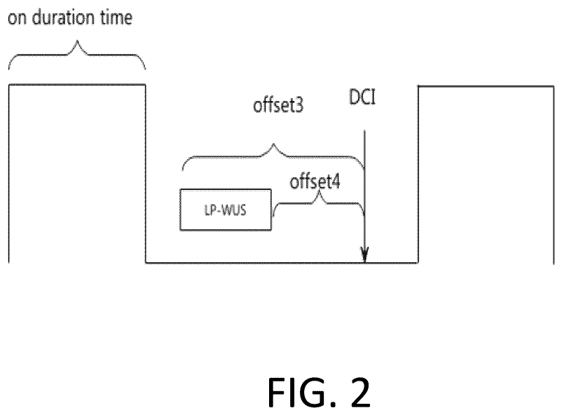

(4) The start time of the occasion of the low power signal can be determined by an offset3 before an occasion of a DCI (Downlink Control Information) with the DCI format 2_6. The gNB may configure the offset3 (e.g., via an RRC message). The UE could determine the start time of the occasion of the low power signal based the offset3 before the occasion of the DCI with the DCI format 2_6 (see FIG. 2).

(5) The end time of the occasion of the low power signal can be determined by an offset4 before the occasion of the DCI with the DCI format 2_6. The gNB may configure the offset4 (e.g., via an RRC message). The UE could determine the end time of the occasion of the low power signal based the offset4 before the occasion of the DCI with the DCI format 2_6 (see FIG. 2).

(6) In the duration time, there are multiple occasions of the low power signal. Each low power signal resource could be a time resource, a frequent resource or a code resource. The number of the occasion of the low power signal could be configured by the gNB (e.g., via an RRC message).

In some embodiments, if each low power signal resource is TDM (time division multiplexing), the time occasion of the low power signal could be determined by one or more of the following: a start time, a duration, a periodicity, and/or an offset (see FIG. 3 and FIG. 4).

In some embodiments, if each low power signal resource is FDM (frequency division multiplexing), the frequency occasion of the low power signal could be determined by one or more of the following: a start frequency, a duration, a periodicity, and/or an offset.

In some embodiments, in the connected mode, the low power signal resource is allocated to the UE by the gNB. The gNB could allocate a UE-specific low power signal resource to the UE via an RRC message, an MAC CE or DCI.

In some embodiments, the low power signal resource is determined by the one or more of the following:

(1) The gNB may, transmit to the UE via an RRC message or broadcast via an SIB, a low power signal resource pool. The configuration of the low power signal resource pool could include the parameters described above.

(2) The low power signal resource is determined by an index. The gNB could allocate the UE an index, and the index is related with the low power signal resource via an RRC message. The UE could monitor the low power signal with the corresponding index.

(3) The gNB could enable the low power signal via an MAC CE. The MAC CE could carry an enabling indication that enables the low power signal. The MAC CE could carry an index, and the index is related with the low power signal resource via an RRC message. The UE could monitor the low power signal with the corresponding index.

(4) The gNB could enable the low power signal via DCI. The DCI could carry an enabling indication that enables the low power signal. The DCI could carry an index, the index is related with the low power signal resource via an RRC message.

In some embodiments, the UE could monitor the low power signal with the corresponding index.

### Aspect 5 (DCI for DCP)

In some embodiments, in a duration, there are multiple occasion of the low power signal. Each occasion may correspond with a UE or a group of UEs. In other words, a UE or a group of UEs could monitor an occasion of the low power signal. If a UE or a group of UEs detects the corresponding low power signal, the UE(s) wake up.

In some embodiments, in the connected mode, the UE could monitor the DCI for the DCP (DCI with CRC (cyclic redundancy check) scrambled by the PS-RNTI (Power Saving-Radio Network Temporary Identifier)), such as a DCI format 2-6. This DCI could carry the information for multiple UEs, and for each UE, this DCI could indicate the UE to monitor or not monitor the PDCCH during the next occurrence of the on-duration.

In some embodiments, if the UEs only monitor the DCI for the DCP, those UEs that does not need to monitor the PDCCH are falsely wake up. The low power signal could wake up some UEs at first, and then the DCI for the DCP could indicate this UE whether it will be scheduled. In this way, the false wake up rate will be reduced.

Thus, the group for the low power signal can be considered. In some embodiments, the UE in the same group could monitor the same low power signal resource. If this low power signal is transmitted, the UEs in the same group are waken up. Then, the UEs could monitor the DCI for the DCP.

In some embodiments, the low power signal resource is determined by one or more of the following:

(1) The low power signal resource is determined by an identity. The gNB could allocate the UE an identity, the identity is related with the low power signal resource. For example, when there are multiple occasions of the low power signal in a duration, the gNB could allocate the UE an identity based on the traffic. If the traffic has lots of data to be scheduled, the gNB could allocate the UEs with the similar traffic a same identity. This identity is related with a low power signal resource. The UE with the same identity could monitor the same low power signal resource. If a low power signal is transmitted, the UE related to this low power signal could wake up.

(2) The low power signal resource is determined by ps-PositionDCI (Starting position of a UE in the DCI for the DCP). For example, when there are multiple occasions of the low power signal in a duration, the gNB may configure the UE a ps-PositionDCI, and the ps-PositionDCI or (ps-PositionDCI mod number of the low power signal (e.g., the maximum number of the low power signal in a duration)) is related to a low power signal resource. The UE with the same ps-PositionDCI or (ps-PositionDCI mod number of the low power signal (the maximum number of the low power signal in a duration)) could monitor the same low power signal resource. If a low power signal is transmitted, the UE related with this low power signal could wake up.

(3) The low power signal could carry an identity. The gNB could allocate the UE an identity. For example, the gNB could allocate the UE an identity based on the traffic. If the traffic has lots of data to be scheduled, the gNB could allocate the UEs with the similar traffic a same identity. If the low power signal could carry an identity, the UE with the same identity could wake up.

(4) The low power signal could carry a time information that the UE could stop monitoring the PDCCH. The low power signal could carry a duration. During this duration, the UE could stop monitoring the PDCCH.

(5) The low power signal could carry a time information that the UE could start monitoring the PDCCH. The low power signal could carry a duration. During this duration, the UE could monitor the PDCCH.

### Aspect 6

In some embodiments, the UE could stop monitoring the PDCCH for power saving. For example, the DCI could indicate the UE not monitoring the PDCCH during the active time for the next DRX cycle, so that the UE does not monitor the PDCCH and does not start the on-duration timer for the next DRX cycle. However, if the data arrive, because the UE does not monitor the PDCCH, the delay for data transmission increases. Hence, the low power signal could wake up the UE to monitor the PDCCH timely.

In some embodiments, the low power signal could wake up the UE to monitor the PDCCH by one or more of the following:

(1) The gNB could enable the UE to monitor the low power signal when the UE does not monitor the PDCCH. If the UE detects the low power signal, the UE could start to monitor the PDCCH.

(2) If the DCI has indicated the UE not monitoring the PDCCH during the active time for the next DRX cycle, the UE does not monitor the PDCCH and does not start the on-duration timer for the next DRX cycle. The UE could monitor the low power signal. If the UE detects the low power signal, or the low power signal carries the indication indicating the UE could wake up or the UE could monitor the PDCCH, the UE could start monitoring the PDCCH. Also, the UE could start the on-duration timer or another timer. If the on-duration timer or said another timer is running, the UE could monitor the PDCCH.

The length of the on-duration timer or said another timer could be the remaining time of the on-duration timer. For example, the on-duration timer configured by the RRC is x, the interval between the transmission occasions of the low power signal and the starting time of the duration timer is y, the remaining time of the on-duration timer is (x-y).

The length of the on-duration timer or said another timer could be configured by an RRC message or broadcast by an SIB.

The length of the on-duration timer or said another timer could be indicated by the low power signal. The low power signal could carry a duration.

(3) If the DCI has indicated the UE not monitoring the PDCCH during a time, the UE does not monitor the PDCCH for this time. The UE could monitor the low power signal instead. If the UE detects the low power signal, or the low power signal carry the indication indicating the UE could wake up or the UE could monitor the PDCCH, the UE could start monitoring the PDCCH for this time.

The length of this time could be configured by an RRC message or broadcast by an SIB.

The length of this time could be indicated by the low power signal. The low power signal could carry a duration. The length of this time is set as the duration carried by the low power signal.

### Aspect 7 (on Duration)

In some embodiments, if the UE detects the low power signal, the UE could wake up and start the on-duration timer according to the configuration of the DRX cycle. However, after the UE detects the low power signal, the UE may spend a ramp up time to turn on some radio components. In other words, the UE could monitor the PDCCH after a ramp up time following the low power signal.

In order to keep the alignment between the gNB and the UE, one or more of the following may be used.

(1) If the UE detect the low power signal, the UE could start the on-duration time at the start time determined by one of the methods described below. If the UE does not detect the low power signal, the UE may not start the on-duration time at the start time determined by any of the methods described below.

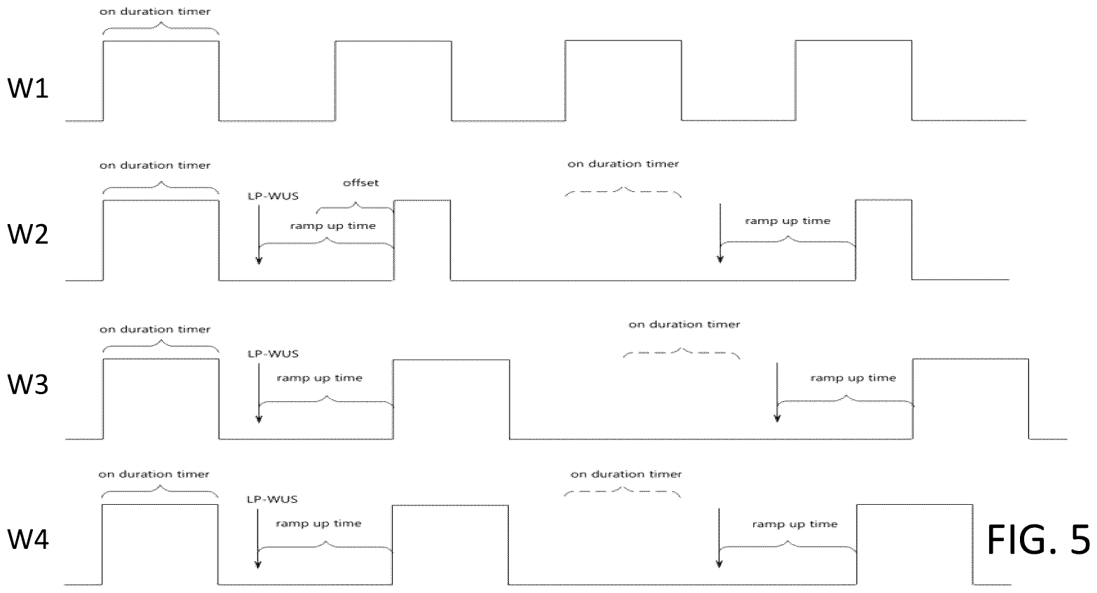

(2) As illustrated in FIG. 5 (e.g., the signal W2), the UE could delay starting the on-duration timer and shorten the on-duration timer. If the UE detects the low power signal, the UE could start the on-duration timer after an offset following the low power signal and shorten the length of the on-duration timer by an offset.

The offset could be determined by the transmission occasion of the low power signal, the ramp up time and the start time of the DRX cycle. For example, the offset=the ramp up time−(the transmission occasion or ending time of the low power signal−the start time of the DRX cycle). The offset could be configured via an RRC message or broadcast via an SIB by the gNB.

The new start time of the DRX cycle=the start time determined by the RRC configuration+offset. The new length of the on-duration timer=(length of the on-duration timer determined by the RRC configuration-offset).

If the UE detects the low power signal, the UE could start the on-duration timer at the new start time and apply the new length of the on-duration timer. In the next DRX cycle, the UE could discard the new start time and the new length of the on-duration timer.

If the UE does not detect the low power signal, the UE could apply the start time and length of the on-duration time determined by the RRC configuration.

In this way, the following DRX cycle could remain the same (e.g., the same as the DRX cycle in the signal W1).

(3) As illustrated in FIG. 5 (e.g., the signal W3), the UE could delay starting the on-duration timer. If the UE detect the low power signal, the UE could start the on-duration timer after an offset following the low power signal.

The offset could be determined by the transmission occasion of the low power signal, the ramp up time and the start time of the DRX cycle, for example, the offset=the ramp up time−(the transmission occasion or ending time of the low power signal−the start time of the DRX cycle). The offset could be configured via an RRC message or broadcast via an SIB by the gNB.

The new start time of the DRX cycle=the old start time+offset·the old start time is the start time of the previous DRX cycle.

If the UE detect the low power signal, the UE could start the on-duration timer at the new start time and apply the length of the on-duration time determined by the RRC configuration.

If the UE does not detect the low power signal, the UE could apply the length of the on-duration time determined by the RRC configuration and apply the start time of the on-duration time determined by the previous DRX cycle.

In this way, the length of the on-duration timer and the occasion for scheduling could remain the same (e.g., the same as the length of the on-duration timer and the occasion for scheduling in the signal W1).

(4) As illustrated in FIG. 5 (e.g., the signal W4), The UE could delay starting the on-duration timer and shorten the non-active timer. If the UE detect the low power signal, the UE could start the on-duration timer after an offset following the low power signal.

The offset could be determined by the transmission occasion of the low power signal, the ramp up time and the start time of the DRX cycle, for example, the offset=the ramp up time−(the transmission occasion or ending time of the low power signal−the start time of the DRX cycle). The offset could be configured via an RRC message or broadcast via an SIB by the gNB.

The new start time of the DRX cycle=the start time determined by the RRC configuration+offset.

If the UE detect the low power signal, the UE could start the on-duration timer at the new start time and apply the length of the on-duration time determined by the RRC configuration. In the next DRX cycle, the UE could discard the new start time.

If the UE does not detect the low power signal, the UE could apply the length of the on-duration time determined by the RRC configuration and apply the start time of the on-duration time determined by the RRC configuration.

In this way, the length of the on-duration timer and the occasion for scheduling could remain the same (e.g., the same as the length of the on-duration timer and the occasion for scheduling in W1).

### Aspect 8 (Long DRX)

In some embodiments, the gNB may configure the UE a long DRX (Discontinuous Reception) cycle configuration via one or more of the following:

(1) The gNB may configure a long DRX cycle configuration for the low power signal via an RRC message. The RRC message could be an RRC reconfiguration or another message. The configuration of the long DRX cycle could include one or more of the following: a start time, a duration and/or a periodicity. The length of the non-active time could be longer than a ramp up time of the low power signal. If the UE would like to enter a deep sleep mode for power saving and monitoring the low power signal, this DRX cycle could be configured or enabled. If this long DRX cycle for the low power signal is enabled, the UE could monitor the low power signal during the non-active time or when the on-duration time is not running.

(2) The DRX cycle configuration for the low power signal could be enabled via an MAC CE in an RRC connected mode. The DRX Command MAC CE for the low power signal is identified by an MAC subheader with an LCID (Logical Channel ID). It may have a fixed size of zero bits. If the UE receives a DRX Command MAC CE for the low power signal, the DRX cycle configuration for the low power signal is enabled and applied, and the UE could start an on-duration timer based on the DRX cycle configuration for the low power signal.

(3) The DRX cycle configuration for the low power signal could be enabled via DCI in an RRC connected mode. The DCI could carry the indication of enabling the DRX cycle configuration for the low power signal. If the UE receives the DCI, and the DRX cycle configuration for the low power signal is enabled, the DRX cycle configuration for the low power signal is applied, and the UE could start an on-duration timer based on the DRX cycle configuration for the low power signal.

(4) The gNB may, transmit to the UE via an RRC message or broadcast via an SIB, a long DRX cycle configuration for the low power signal. The RRC message could be an RRC release or another message. The configuration of the long DRX cycle could include a periodicity. The length of periodicity could be longer than a ramp up time of the low power signal. If the UE enables the long DRX cycle configuration or the low power signal, the UE could apply this long DRX cycle configuration in the RRC idle/inactive mode.

### Aspect 9 (Starting Condition)

In some embodiments, if the UE is not camped on a high-priority frequency, it may initiate neighbor cell measurements and attempt to camp on a high-priority frequency.

In some embodiments, while the UE activates the MR to measure the SSB of the neighboring cells, the UE does not perform the relaxed serving cell measurement based on the low power signal.

In some embodiments, the measurement of the SSB in the serving cell requires the UE to wake up and turn on the MR. In order to save the UE power consumption, the UE may perform the relaxed measurement in the serving cell. The relaxed measurement in the serving cell includes that the UE measures or monitors the low power signal instead of the SSB in the serving cell, or the UE measures or monitors the SSB in the serving cell in every longer periodicity.

In some embodiments, if the frequency is broadcasted by the SIB with the higher priority in the serving cell, the UE may prioritize measurements of the higher priority inter-frequency or inter-RAT (Radio Access Technology) frequencies.

In the idle/inactive mode, in order to save the power of the UE, the relaxed measurement in the serving cell can be one or more of the following:

(1) If the UE does not camp on the frequency (including the inter-frequency or the inter-RAT frequency) with the higher priority, the UE may not perform the serving cell measurement based on the low power signal or the relaxed serving cell measurement based on the low power signal. If the frequency with the higher priority in the serving cell is broadcasted by the SIB, and the UE could satisfy the condition of the serving cell measurement based on the low power signal, or the relaxed serving cell measurement, the UE may perform measurements of the higher priority inter-frequency or inter-RAT frequencies. To enable the UE to reselect to the frequency with the higher priority, the serving cell measurement may not be relaxed or performed in a long periodicity. In this way, the UE may not perform the serving cell measurement based on the low power signal or the relaxed serving cell measurement based on the low power signal.

(2) If a certain period has passed since the UE camp on the serving cell or a certain period has passed since the UE measures the frequency with the higher priority, the UE may perform the serving cell measurement based on the low power signal or the relaxed serving cell measurement based on the low power signal. This certain period could be configured by the gNB via an SIB. If the UE camps on the serving cell for a certain period, the signal quality of the neighbor cell with a higher priority may could not satisfy the S criteria (e.g., the cell selection criteria S, in which if a cell fulfills the cell selection criteria S, this cell could be a candidate cell during cell reselection procedure) or Cell Reselection criteria, the UE may camp on the serving cell. To saving the UE power, the UE may perform the serving cell measurement based on the low power signal or the relaxed serving cell measurement based on the low power signal, the UE could stop the measurements for the frequency with the higher priority.

(3) If the signal quality of the serving cell is higher than a threshold, and SIB broadcast the frequency with the higher priority in the serving cell, the UE may perform the serving cell measurement based on the low power signal or the relaxed serving cell measurement based on the low power signal. If the signal quality of serving cell is higher than a threshold, and the UE could satisfy the condition of the serving cell measurement based on the low power signal, or the relaxed serving cell measurement (for example, the RSRP (reference signal received power) of the serving cell is higher than a threshold and/or RSRQ (reference signal received quality) of the serving cell is higher than a threshold), this means the signal quality of the serving cell is good enough. To saving the UE power, the UE may perform the serving cell measurement based on the low power signal or the relaxed serving cell measurement based on the low power signal, and the UE could stop the measurement for the frequency with the higher priority.

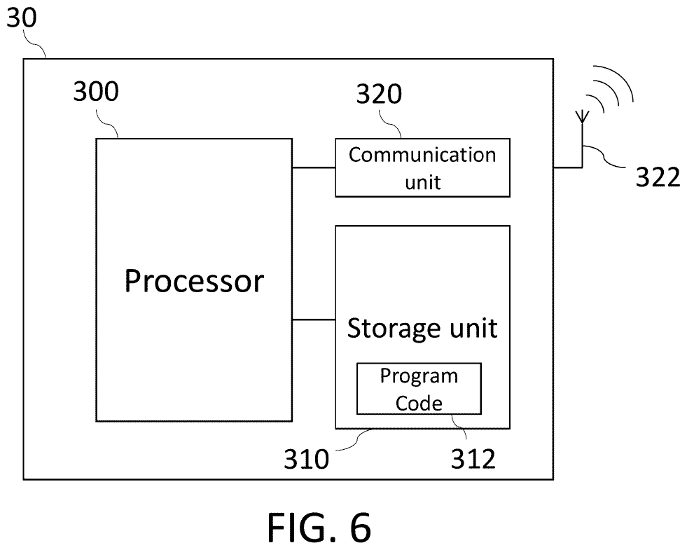

FIG. 6 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described in this disclosure. In some embodiments, the processor 300 and the communication unit 320 collaboratively perform the operations described in this disclosure. For example, the processor 300 performs operations and transmit or receive signals, message, and/or information through the communication unit 320.

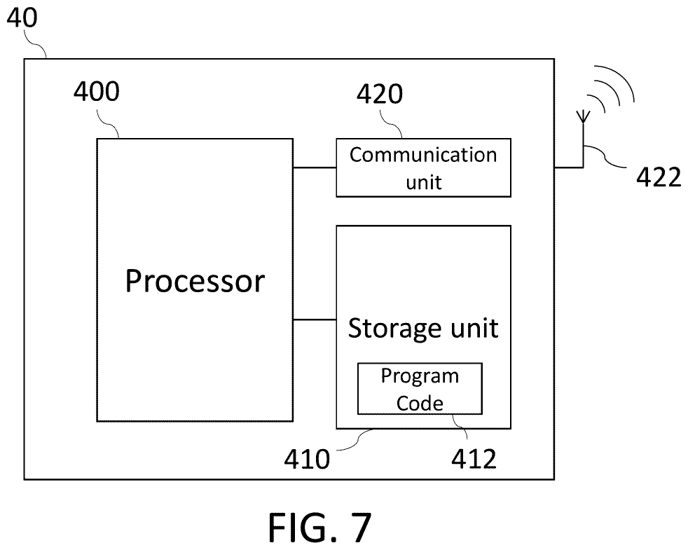

FIG. 7 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the gNB described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the gNB described in this disclosure. In some embodiments, the processor 400 and the communication unit 420 collaboratively perform the operations described in this disclosure. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described in this disclosure, but is not limited thereto.

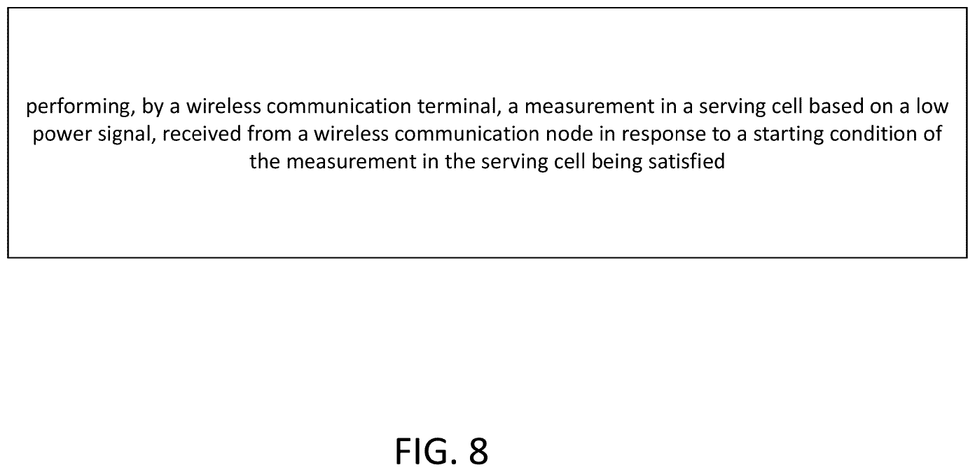

Referring to FIG. 8, in an embodiment, the wireless communication method includes: performing, by a wireless communication terminal, a measurement in a serving cell based on a low power signal, received from a wireless communication node in response to a starting condition of the measurement in the serving cell being satisfied.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB). In an embodiment, the wireless communication node may be implemented by using the wireless communication node 40 described in this disclosure, but is not limited thereto.

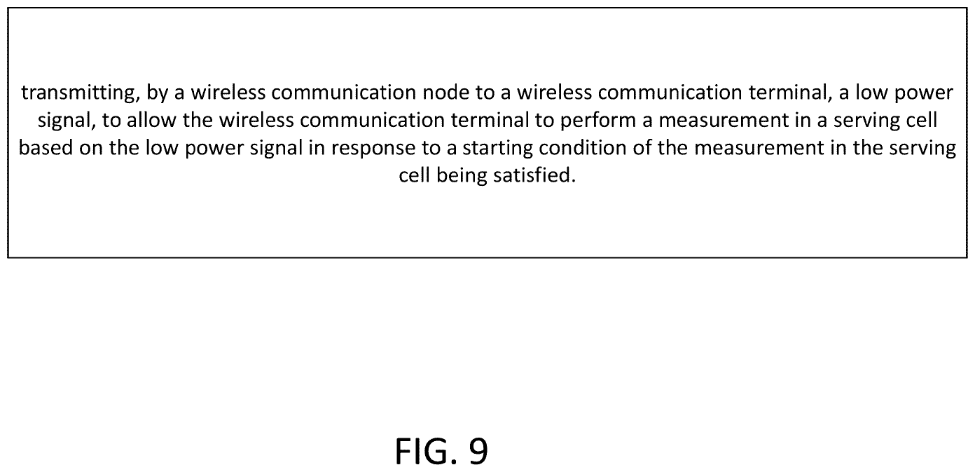

Referring to FIG. 9, in an embodiment, the wireless communication method includes transmitting, by a wireless communication node to a wireless communication terminal, a low power signal, to allow the wireless communication terminal to perform a measurement in a serving cell based on the low power signal in response to a starting condition of the measurement in the serving cell being satisfied.

Details in this regard can be ascertained with reference to the paragraphs above, and will not be repeated herein.

In some embodiments, the wireless communication terminal used in the present disclosure may indicate the UE described above.

In some embodiments, the wireless communication node used in the present disclosure may indicate the gNB described above.

In some embodiments, the measurement described in the methods above may indicate the relaxed serving cell measurement described above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
performing, by a wireless communication terminal, a measurement in a serving cell based on a low power signal, received from a wireless communication node in response to a starting condition of the measurement in the serving cell being satisfied.

2. The wireless communication method of claim 1, wherein the starting condition of the measurement is determined according to a configuration transmitted from the wireless communication node to the wireless communication terminal.

3. The wireless communication method of claim 1, wherein an enablement indication for allowing the wireless communication terminal to determine the starting condition of the measurement is transmitted from the wireless communication node to the wireless communication terminal.

4. The wireless communication method of claim 1, wherein the measurement in the serving cell based on the low power signal comprises:
a Radio Resource Management (RRM) measurement based on the low power signal.

5. The wireless communication method of claim 4, wherein RRM configuration is applied for the measurement in response to the starting condition of the measurement is satisfied.

6. The wireless communication method of claim 1, wherein the starting condition of the measurement comprises:
a measurement result of an SSB being greater than a summation of a threshold and an offset.

7. The wireless communication method of claim 1, wherein the low power signal comprises: a Low Power Synchronization Signal (LP-SS).

8. A wireless communication method comprising:
transmitting, by a wireless communication node to a wireless communication terminal, a low power signal, to allow the wireless communication terminal to perform a measurement in a serving cell based on the low power signal in response to a starting condition of the measurement in the serving cell being satisfied.

9. The wireless communication method of claim 8, wherein the starting condition of the measurement is determined according to a configuration transmitted from the wireless communication node to the wireless communication terminal.

10. The wireless communication method of claim 8, wherein an enablement indication for allowing the wireless communication terminal to determine the starting condition of the measurement is transmitted from the wireless communication node to the wireless communication terminal.

11. The wireless communication method of claim 8, wherein the measurement in the serving cell based on the low power signal comprises:
a Radio Resource Management (RRM) measurement based on the low power signal.

12. The wireless communication method of claim 11, wherein an RRM configuration is applied for the measurement in response to the starting condition of the measurement is satisfied.

13. The wireless communication method of claim 8, wherein the starting condition of the measurement comprises:
a measurement result of an SSB being greater than a summation of a threshold and an offset.

14. The wireless communication method of claim 8, wherein the low power signal comprises a Low Power Synchronization Signal (LP-SS).

15. A wireless communication terminal, comprising:
a communication unit; and
a processor configured to: perform a measurement in a serving cell based on a low power signal, received from a wireless communication node through the communication unit in response to a starting condition of the measurement in the serving cell being satisfied.

16. The wireless communication terminal of claim 15, wherein the starting condition of the measurement is determined according to a configuration transmitted from the wireless communication node to the wireless communication terminal.

17. The wireless communication terminal of claim 15, wherein an enablement indication for allowing the wireless communication terminal to determine the starting condition of the measurement is transmitted from the wireless communication node to the wireless communication terminal.

18. The wireless communication terminal of claim 15, wherein the measurement in the serving cell based on the low power signal comprises:
a Radio Resource Management (RRM) measurement based on the low power signal.

19. The wireless communication terminal of claim 18, wherein an RRM configuration is applied for the measurement in response to the starting condition of the measurement is satisfied.

20. The wireless communication terminal of claim 15, wherein the starting condition of the measurement comprises a measurement result of an SSB being greater than a summation of a threshold and an offset; and
wherein the low power signal comprises a Low Power Synchronization Signal (LP-SS).
